(19) United States
(12) Patent Application Publication
(10) Pub. No.: US 2006/0199757 A1
(43) Pub. Date: Sep. 7, 2006

(54) Detergent composition and method of using same

(76) Inventor: Lance L. Renfrow, Gilbert, AZ (US)

Correspondence Address: The Weintraub Group, P.L.C., Suite 240, 32000 Northwestern Highway, Farmington Hills, MI, 48334, US

(21) Appl. No.: 11/070,997

(22) Filed: Mar. 3, 2005

(51) Int. Cl. C11D 3/37

(52) U.S. Cl. 510/499

(57) ABSTRACT

A detergent blend is prepared by admixing together a fluorinated surfactant and an amphoteric-based sultaine surfactant hydrotrope. This blend can then be formulated into a detergent concentrate which includes a caustic compound, a chelant, a descaler, and other adjuvants to enable the concentrate to be diluted into a use solution for use in either an acid or base environment. The use solution prepared from the detergent blend is particularly useful in cleaning draft beer lines, dairy lines, and other applications where highly concentrated alkaline or acid-based solutions are used for cleaning.

### BACKGROUND OF THE INVENTION

1. Field of the Invention

The present invention concerns detergent compositions and methods of use therefor. More particularly, the present invention concerns detergent concentrates and use solutions prepared therefrom. Even more particularly, the present invention concerns detergent concentrates and use solutions prepared therefrom and methods of use therefor.

2. Prior Art

In United States Patent Application Publication No. 20020037821, published Mar. 28, 2002 for “Detergent Compositions and Methods” and U.S. patent application Ser. No. 10,393,741, filed Mar. 21, 2003, the disclosures of which are hereby incorporated by reference in their entirety, there is disclosed, respectively, a detergent composition which comprises a mixture or blend of a high cloud point and low cloud point surfactant and a caustic stable as well as acid stable fluorosurfactant hydrotrope composition. These blends have a particular utility in cleaning brewery and food processing apparatus as well as other applications requiring highly concentrated alkaline or acid-based cleaners. According to the inventions defined therewithin, the use solution mixture or blend has a very low surface tension, is low foaming, and is compatible in both caustic and acid environments.

The present invention, as will subsequently be detailed hereinafter, provides an improved formulation over that of the above-referred to prior art in that a single surfactant is ultimately hydrotroped into the use solution and as a consequence thereof, affords a use solution with a much lower surface tension, lower foam and enhanced rinseability estimated to be at least five-fold over the prior art. Necessarily, then, less material is used providing a major cost savings, with a concomitant reduction in cleaning time to provide a more efficient process and a much cleaner system.

### SUMMARY OF THE INVENTION

In accordance herewith, there is provided a detergent blend which, generally, comprises:

(a) a fluorinated surfactant, and

(b) an amphoteric-based surfactant hydrotrope.
This detergent blend is employed in a detergent concentrate from which is prepared a use solution compatible in both a highly concentrated alkaline or caustic and/or an acid environment and which is particularly useful for cleaning protein deposits on food contact surfaces including, for example, in brewery apparatus, beer delivery lines, as well as in dairy and other related food processing apparatus. This invention can also be used in other applications where highly concentrated alkaline or acid-based solutions are utilized.

For a more complete understanding of the present invention reference is made to the following detailed description and accompanying examples.

### BRIEF DESCRIPTION OF THE DRAWING

FIG. 1 is a graph showing the spreading properties of the detergents hereof.

### DESCRIPTION OF THE PREFERRED EMBODIMENT

As hereinabove note and in accordance herewith, there is provided a detergent blend which, generally, comprises:

(a) a fluorinated surfactant, and

(b) an amphoteric-based surfactant hydrotrope.

This detergent blend is employed in a detergent concentrate from which is prepared a use solution compatible in either a caustic or an acid environment and which is useful for cleaning protein deposits in brewery apparatus as well as dairy and other related food processing apparatus.

With more particularity and as noted, the surfactant used in the blend, is a fluorinated surfactant. Such fluorinated surfactants are anionic, nonionic or cationic having one or more fluorine atoms incorporated thereinto either into the backbone of the surfactant or as a branched substituent.

Among the useful fluorinated surfactants are those which correspond to the formulae:
(CF₂CF₂)ₙ (RO) X
or
CF₃—CF₂ (CF₂CF₂)ₙ (CH₂)_{y} X
wherein n is an integer ranging from 1 to about 9, y is an integer ranging from about 0 to about 15 and X is wither hydrogen or an anionic radical, which may be selected from the group consisting of sulfate, sulfonate, phosphate, phosphonate, ammonium, thiosulfate, thiosulfonate, and the like, as well as mixtures thereof

Particularly preferred surfactants are those sold by DuPont under the trademark Zonyl, and, in particular, Zonyl FSP and Zonyl FSO. Zonyl FSP is described as a perfluorinated anionic functional compound comprising about a 50:50 weight mixture blend of a linear C₄ to C₁₄ perfluoro alkyl ethyl phosphonate acid and a perfluoro alkyl ethyl phosphonic acid surfactant.

Zonyl FSO is described as a fluorinated nonionic surfactant corresponding to the formula:
R_{f}CH₂CH₂O (CH₂CH₂O)ₓH
Where R_{f}=F(CF₂CF₂)ₙ and ₙ is an integer from about 1 to about 7, x is an integer from about 1 to about 15.

It should be noted that the surfactant is selected depending on the desired foaming conditions. Thus, in a low foam environment, the Zonyl FSP would be employed and in a high foam situation the FSO would be employed.

Other useful fluoro surfactants are those sold by Innovative Chemical Technologies, Inc. under the trademarks Flexiwet NF and Flexiwet AB28 and Flexiwet AB29. Flexiwet AB29 is described as a perfluorinated anionic functional compound comprising about a 50:50 weight mixture blend of a linear C₄ to C₁₄ perfluoro alkyl ethyl phosphonate acid and a perfluoro alkyl ethyl phosphonic acid surfactant.

Additionally, a fluorinated alkyl glucoside surfactant may be used herein, as well. Such surfactants are, also, well known and commercially available.

Although any of the denoted surfactants may be used herein, the Zonyl-brand fluoro surfactants have been found to be superior in reducing surface tension.

The fluorinated surfactant will generally comprise from about 0.5% to about 5.0% by weight of the blend and, preferably, from about 2.0% to about 4.0% by weight of the blend.

The second compound or component of the blend is an amphoteric hydrotrope. Preferably, this hydrotrope is a sultaine-based hydrotrope and, more preferably, an alkyl ether hydroxyl propyl sultaine. Such a hydrotropic compound is sold commercially under the name Miratine ASC. Generally, the hydrotrope will comprise from about 95.0% to about 99.5%, by weight, based upon the total weight of the detergent blend and, preferably, from about 96.0% to about 98.0%, by weight of the total weight of the detergent blend.

The detergent blend hereof is used to prepare a detergent concentrate therefrom. In manufacturing the concentrate, the surfactant or detergent blend is present in an amount ranging from about 0.5% to about 1.0%, by weight, based upon the total weight of the concentrate.

The concentrate, preferably, comprises an aqueous solution of a base or caustic material, a chelant, a dispersant, a scale inhibitor, the detergent blend and water.

The caustic or base is, preferably, an alkali metal hydroxide, such as, sodium hydroxide, potassium hydroxide, and the like as well as mixtures thereof Other compounds useful as a base include, for example, alkali metal carbonates, alkali metal bicarbonates and the like. Preferably, though, the caustic or base material is sodium hydroxide because of its superior properties as a soap. Sodium hydroxide is typically employed as a 50% aqueous solution thereof. Generally, the caustic material, as the 50% aqueous solution, comprises from about 90% up to about 95% by weight of the total weight of the concentrate.

Herein, and preferably, from about 1% to about 10% of the 50% aqueous caustic solution is used in the final formulation or use solution.

As noted, the concentrate further includes a least one chelant. Because of its non-corrosive properties the preferred chelants are the alkali metal salts of gluconic acid including sodium gluconate, sodium glucoheptonate, 1-methyl glucoside and the like. Mixtures of chelants can be used.

Generally, the chelant will be used in an amount ranging from about 1.0% to about 5.0%, by weight, and based on the total weight of the concentrate and, preferably, from about 1% to about 3.5% weight percent. In preparing the concentrate, the preferred chelant is sodium gluconate.

As noted, the concentrate further includes a scale inhibitor as well as a dispersant. Any of the well-known inhibitors and dispersants may be use so long as they are chemically compatible with the detergent blend and the base material.

Useful compounds include, for example, DEQUEST 2000, which functions as a buffer and scale inhibitor, which is aminotrismethylene phosphonic acid (ATMP) and the like. Generally, this adjuvant will comprise from about 1.0% to about 2.25%, by weight, of the concentrate.

The balance of the concentrate is water.

The concentrate is prepared by admixing the components together at ambient conditions. The concentrate is a homogeneous solution and is storage stable.

In preparing a use solution or final formulation from the concentrate, the concentrate is admixed with water at ambient conditions with stirring. As noted above, the use solution will generally contain or be about a 1% to about a 10%, by weight, the 50% aqueous caustic solution, based on the caustic in the concentrate.

In other words, the concentrate is diluted with water to achieve a presence therein of about a 1% to about a 10%, by weight, amount of the 50% caustic solution. Thus, the use solution will contain from about 0.5% by weight to about 5% by weight of caustic.

The use solution is deployed by pumping it through the fluid delivery lines, such as a draft line, milk line, etc. In addition, present composition can be used not only for cleaning fluid delivery lines but all food contact surfaces, whether it be liquid or solid. Thus, the present invention, while showing efficacy in cleaning brewery lines, brewery conveyers, etc., is equally applicable for cleaning hard metal surfaces found in food conveyers, non alcoholic beverage environments and the like.

The present detergent composition has exhibited superior capabilities in cleaning draft beer delivery lines, brewery tanks, kegs and cleaning bottles due to its low surface tension.

Generally, such lines will be at a temperature from about 50° F. to above about 200° F. The present composition is effective over this range.

Usually, the composition is pumped through the lines for about 2 to about 30 minutes. Thereafter, the line is rinsed at ambient temperatures with water.

The present invention further contemplates the inclusion of a dye into the cleaner. Usually, the dye is admixed into the final formulation in an amount ranging from about 0.04% to about 0.08%, by weight, and, preferably, about 0.05%, by weight, based on the total weight of the final formulation. The dye enables the detection or absence of the cleaner on the hard surface being cleaned. A particularly useful dye is that sold by BASF under the mark BASACID. A particularly preferred dye is that sold by BASF under the name BASACID Blue 762 which is described as a copper phthalocyanine product. It is not only compatible with the caustic, but the fluorosurfactants, as well. Thus, the rinsing step is repeated, as necessary, until the dye is no longer visible.

The preferred dye is useful in either a pH acid or pH base environment.

As noted, the present detergent blend, when used in a beer environment, is a low foam composition that is water soluble and is useful in both acid and base situations. The fluorinated surfactant lowers the surface tension to a degree that there is less use solution consumption and faster cleaning cycle times.

For a more complete understanding of the present invention, references made to the following non-limiting illustrative examples. In the examples, all parts are by weight absent indications to the contrary.

### EXAMPLE 1

A surfactant blend in accordance herewith is prepared by the following procedure:

Into a suitable vessel equipped with stirring means was added the following, at room temperature:

| Ingredient | Amount (pbw) |
|---|---|
| Miratine ASC Hydrotrope | 97.0 |
| Fluorinated surfactant⁽¹⁾ | 3.0 |
| | 100.0 |

⁽¹⁾Zonyl FSP (35% active)

### EXAMPLE II

This example illustrates the preparation of a detergent concentrate in accordance with the present invention.

Into a suitable vessel equipped with a stirrer is added with stirring:

| Ingredient | Amount, (pbw) |
|---|---|
| Water | 4.00 |
| Sodium Gluconate | 3.25 |
| Dequest 2000 | 2.25 |
| Caustic | 90.00 |
| Surfactant Blend | 0.50 |
| | 100.00 |

⁽¹⁾a 44:1 part blend of Mirataine ASC and Zonyl FSP

This concentrate is useful in brewery cleaning.

### EXAMPLE II

A series of detergent compositions were prepared by adding water to requisite quantities of the concentrate of Example II to form, respectively, a 1%, 2% and 3% caustic concentration detergent. These detergents were then studied for dynamic contact angle (spreading) against PTFE. The following table shows the results of the testing.

| | 3% NaOH | 2% NaOH | |
|---|---|---|---|
| | Surface | Surface | 1% NaOH |
| | Tension | Tension | Surface Tension |
| Test # | (mN/m) | (mN/m) | (mN/m) |
| 1 | 19.46 | 20.37 | 21.67 |
| 2 | 19.42 | 20.39 | 21.68 |
| Average | 19.44 | 20.38 | 21.68 |

The test procedure was as follows:

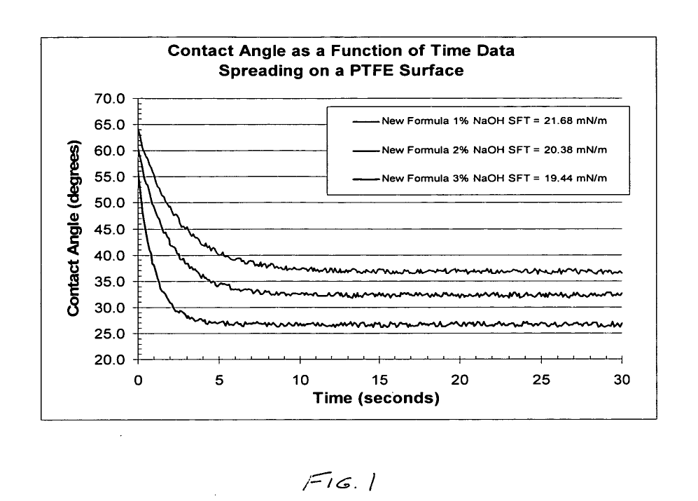

Two drops of each of these solutions were deposited onto PTFE substrate, and then measured the contact angle every 0.1 seconds following droplet placement—for a period of 30 seconds. The resultant contact angle data are shown in FIG. 1.

Having, thus, described the invention what is claimed is:

1. A detergent blend which comprises:
(a) a fluorinated surfactant and
(b) an amphoteric-based surfactant hydrotrope.

2. The detergent blend of claim 1 wherein the hydrotrope is an anphoteric-based sultaine surfactant

3. The detergent blend of claim 2 wherein the fluorinated surfactant is selected from the group consisting of:
F (CF₂CF₂)ₙ (RO)ₓ X
and
CF₃—CF₂(CF₂CF₂)ₙ (CH₂)_{y} X
where R is alkyl from 2 to about 4, n is an integer from 1 to about 9, y is an integer from 0 to about 15 and X is either hydrogen or an anionic radical selected from the group consisting of sulfate, sulfonate, phosphate, phosphonate, ammonium, thiosulfate, thiosulfonate and mixtures thereof.

4. The detergent blend of claim 3 wherein the fluorosurfactant corresponds to the formula:
F (CF₂CF₂)ₙ CF₂CF₂O (CF₂CF₂O)ₓ H
where n is an integer from about 1 to about 7 and x is an integer from about 0 to about 15.

5. The detergent blend of claim 3 wherein the fluorinated surfactant is a perfluorinate anionic functional compound comprising about a 50:50 weight mixture blend of a linear C₄ to C₁₄ perfluoro alkyl ethyl phosphonic acid and a perluoro alkyl ethyl phosphonic acid.

6. The detergent blend of claim 2 which further comprises a second surfactant, the surfactant being an anionic surfactant.

7. A detergent concentrate comprising: from about 0.5% to about 1.0%, by weight, of the blend of claim 2.

8. The concentrate of claim 7 which further comprises: an aqueous caustic material, a chelant, a dispersant, a scale inhibitor, a buffer, and water.

9. The concentrate of claim 8 wherein the base is a 50% aqueous solution of caustic soda.

10. A use solution comprising:
water and the concentrate of claim 7.

11. The use solution of claim 10 wherein: the use solution contains from about 1% to about 10%, by weight, of a 50% aqueous caustic solution.

12. The use solution of claim 10 which further comprises: a dye in solution with the use solution.

13. The use solution of claim 12 wherein:
the dye is a copper phthalocyanine dye.

14. A method of cleaning a food or beverage contact surface which comprises:
contacting the surface with the composition of claim 13.

15. The method of claim 14 wherein:
the contact is done by pumping the composition through a fluid delivery line at a temperature ranging from about 50° F. to about 200° F.

16. The method of claim 15 which further comprises:
rinsing the line at ambient temperatures after pumping the use solution therethrough.

17. The method of claim 16 which further comprises;
continuing to rinse the line until the dye is no longer detectable.
